(19) United States
(12) Patent Application Publication
(10) Pub. No.: US 2018/0153338 A1
(43) Pub. Date: Jun. 7, 2018

(54) TIMER-ACTUATED VALVE ASSEMBLIES FOR BEVERAGE BREWERS AND RELATED METHODS

(71) Applicant: Alpha Dominche Holdings, Inc., Dallas, TX (US)

(72) Inventors: Adam Roth Mangold, Brooklyn, NY (US); Tymer T. Tilton, Brooklyn, NY (US)

(21) Appl. No.: 15/832,583

(22) Filed: Dec. 5, 2017

Related U.S. Application Data
(60) Provisional application No. 62/430,244, filed on Dec. 5, 2016.

(51) Int. Cl. A47J 31/56; A47J 31/10; A47J 31/46

(52) U.S. Cl. CPC A47J 31/56; A47J 31/465; A47J 31/106

(57) ABSTRACT

Brewing assemblies and related brewing methods involving timer-actuated release of a fluid, such as heated water, during a brewing process for brewing and/or for release of the brewed beverage itself. In some embodiments, the brewing assembly may comprise a valve assembly operated by a timer such that a fluid is delivered in desired, preferably intermittent, doses. In some embodiments, the valve assembly may be modular and may allow for substitution of certain components, such as a rotating dial, to select certain recipes and/or preferred brewing characteristics.

### RELATED APPLICATION

This application claims the benefit under 35 U.S.C. § 119(e) of U.S. Provisional Patent Application No. 62/430,244 filed Dec. 5, 2016 and titled “TIMER-ACTUATED VALVE ASSEMBLY FOR BEVERAGE BREWERS AND RELATED METHODS,” which application is incorporated herein by reference in its entirety.

### SUMMARY

Beverage brewers, such as coffee and/or tea brewers are disclosed herein comprising novel valves and/or valve assemblies. In some embodiments, such valve assemblies may be used to deliver a liquid during the brewing process in an intermittent manner to improve the brewing methodology and thereby improve the taste of the resulting brewed beverage and/or allow users to customize the brewing process according to their individual tastes. For example, some embodiments may allow for delivery of heated water onto coffee grounds or another brewing material in intermittent doses, which may improve the resulting beverage as desired by a particular user.

Other features may further improve the brewing process. For example, some embodiments may provide a component for evening the distribution of liquid on the brewing material, such as a rotating dripper. Still other embodiments may utilize a timer that may allow for control over the time during which the brewing material is in contact with the liquid and therefore be used to control the brewing time. For example, in some embodiments, a timer may be used that, upon expiration, opens a valve underneath a brewing area of the device containing the brewing material such that, upon actuation/expiration, the valve allows the brewed beverage to exit the brewing area after a desired period of time according to user taste. In some embodiments, various elements of the device may be modular and/or otherwise adjustable to allow for the number of wetting doses, time between doses, duration of doses, and/or brew time to be adjusted as desired.

In a more particular example of a brewing assembly for brewing a beverage according to some embodiments, the assembly may comprise a liquid chamber configured to receive a liquid for use in brewing a beverage and a valve assembly operably coupled with the liquid chamber. The valve assembly may comprise a valve configured to be repositioned between an open configuration in which a liquid may be delivered through the valve and a closed configuration in which a liquid is prevented from passing through the valve. A timer configured to intermittently actuate the valve between its open and closed configurations may also be provided.

In some embodiments, the brewing assembly may be directly coupled with the liquid chamber such that the liquid chamber is configured to deliver a liquid to the valve of the valve assembly.

Some embodiments may further comprise a delivery chamber configured to receive a brewed beverage following brewing. In some such embodiments, the valve assembly may be positioned and configured to deliver (in some embodiments intermittently) the brewed beverage into the delivery chamber.

In some embodiments, the valve assembly may further comprise a rotating dial configured to intermittently actuate the valve between its open and closed configurations as the rotating dial rotates. In some such embodiments, the rotating dial may comprise one or more (in some embodiments, a plurality) lobes. The lobe(s) may be configured to open the valve when aligned with the valve.

In some embodiments, the rotating dial may be removable and replaceable with other dials configured to provide for distinct brewing characteristics/recipes. For example, in some embodiments, the brewing assembly may comprise a second rotating dial that differs from the rotating dial, and the brewing assembly may be configured to allow the second rotating dial to be installed in place of the rotating dial to alter the brewing characteristics of the brewing assembly.

Some embodiments may further comprise a rotating dripper configured to deliver a liquid onto a brewing material. In some such embodiments, the rotating dripper may be operably coupled with the valve assembly such that the brewing assembly is configured to rotate the rotating dripper as the valve is intermittently actuated between its open and closed configurations.

In some embodiments, the timer may comprise a winding key configured to allow for resetting the timer. Some embodiments may further comprise a trigger configured to actuate the timer.

In an example of a brewing assembly for brewing a beverage according to other embodiments, the brewing assembly may comprise a liquid chamber configured to receive a liquid for use in brewing a beverage; a brewing chamber configured to receive brewing material for brewing a beverage; and a delivery chamber configured to receive a brewed beverage from the brewing chamber. Some embodiments may further comprise a valve assembly, which may be positioned in between the liquid chamber and the delivery chamber. The valve assembly may comprise a shaft; a non-circular rotating dial coupled with the shaft; and a valve configured to be repositioned between an open configuration in which the liquid from the liquid chamber may be delivered through the valve into the brewing chamber and a closed configuration in which a liquid is prevented from passing through the valve. The shaft may be configured to rotate to intermittently actuate the valve between its open and closed configurations by rotating the non-circular rotating dial.

Some embodiments may further comprise a winding key coupled with the shaft, which may be used to reset the timer.

Some embodiments may further comprise a trigger configured to, upon actuation, rotate the shaft.

In an example of a method for brewing a beverage according to some implementations, the method may comprise loading a brewing material into a brewing chamber of a beverage brewer. A timer of the beverage brewer may be actuated, such as by actuating a trigger mechanism. Upon actuation of the timer, a liquid may be delivered in an intermittent manner through a valve of the beverage brewer, such as by delivering a heated liquid into a brewing chamber in an intermittent manner. A beverage may be brewed, in some implementations after delivering the liquid through the valve, using the beverage brewer.

In some implementations, the step of actuating the timer of the beverage brewer may result in automatically delivering the liquid through the valve in an intermittent manner.

In some implementations, the step of actuating the timer of the beverage brewer may cause a shaft to rotate. In some such implementations, the shaft may comprise a cam member. The rotation of the cam member may be configured to cause the valve to intermittently open and close.

In some implementations, the method may further comprise resetting the timer after the step of brewing the beverage, which may be done, for example, by turning a winding key or, in electronic embodiments, by electronically resetting the timer.

In some implementations, the step of delivering a liquid in an intermittent manner through a valve of the beverage brewer may comprise delivering a liquid from a liquid chamber of the beverage brewer into the brewing material in the brewing chamber.

The features, structures, steps, or characteristics disclosed herein in connection with one embodiment may be combined in any suitable manner in one or more alternative embodiments.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of a brewing assembly according to some embodiments;

FIG. 2 is an exploded, perspective view of the brewing assembly of FIG. 1;

FIG. 3 is a cross-sectional view of the brewing assembly of FIGS. 1-2;

FIG. 4 is a close-up, perspective view of a timer-actuated valve assembly of a brewing assembly according to some embodiments;

FIGS. 5-9 are close-up, perspective views of the timer-actuated valve assembly of FIG. 4 in various stages of operation;

FIG. 10 is a partial, cross-sectional view of the timer-actuated valve assembly of FIGS. 5-9 during operation;

FIGS. 11-14 are cross-sectional views of an entire brewing assembly according to certain embodiments during operation; and

FIG. 15 is an exploded, perspective view of the brewing assembly following a brewing process.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In some cases, well-known structures, materials, or operations are not shown or described in detail.

Various embodiments of apparatus and methods are disclosed herein that relate to hot beverage brewers, such as coffee and/or tea brewers. Some embodiments disclosed herein provide for timer-actuated release of a liquid or other fluid, such as, for example, heated water for use in brewing a beverage and/or for dispensing the beverage after brewing.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

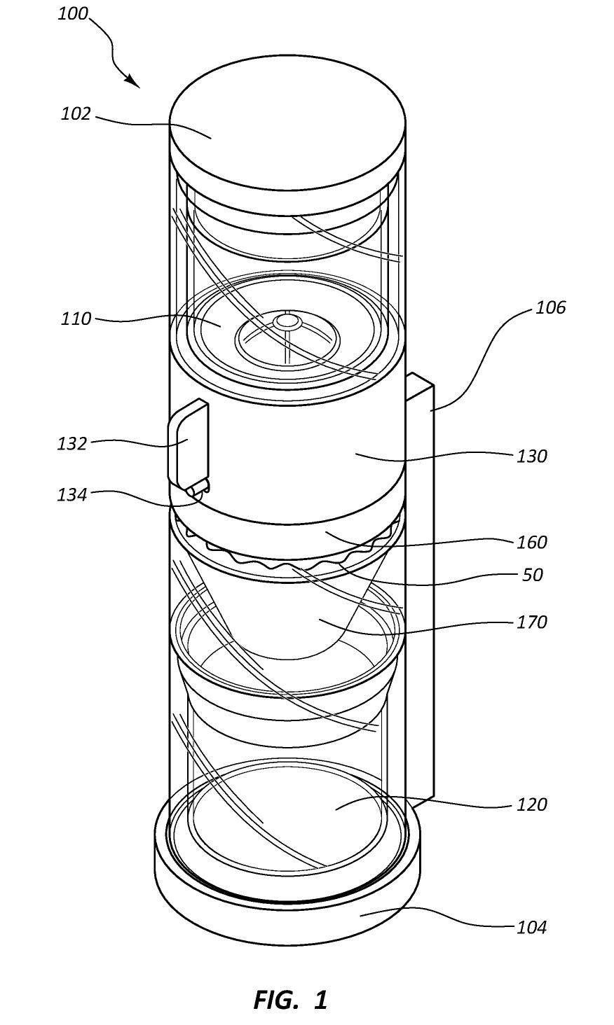

FIG. 1 depicts a first embodiment of a brewing assembly 100 comprising a timer-actuated valve assembly. Brewing assembly 100 comprises a lid 102, a base 104 positioned at the opposite end of brewing assembly 100 relative to lid 102, and a frame member 106, which may, in some embodiments, serve as a handle to allow for easier movement of the assembly 100. A liquid chamber 110 is positioned at the upper end of assembly 100 and is configured to be accessed by lid 102. A delivery chamber 120 is positioned at the lower end of assembly immediately above base 104. In some embodiments, delivery chamber 120 may be removable from brewing assembly 100. Thus, for example, in some such embodiments, delivery chamber 120 may comprise a carafe that may allow a user to dispense the brewed beverage after brewing.

As will be described below in detail, a series of elements, features, and/or sub-assemblies may be positioned in between liquid chamber 110 and delivery chamber 120 such that a liquid, such as heated water, may be selectively delivered between liquid chamber 110 and delivery chamber 120. More particularly, a central chamber 130 may be positioned below liquid chamber 110. In preferred embodiments, again, as discussed below, central chamber may comprise a timer-actuated valve assembly such that a liquid or fluid, such as heated water, may be delivered into a brewing area and/or chamber and/or area, and/or such that a liquid following brewing may be delivered out of the brewing area and/or chamber, in a desired manner. For example, in some embodiments, a timer may be used to dose heated water or another liquid into coffee grounds, tea leaves and/or grounds, or another brewing material, at selected intervals. Similarly, in some embodiments, a timer may be used to deliver a brewed beverage out of a brewing area and/or chamber at selected intervals.

Brewing assembly 100 further comprises a timer reset member 132, which in the depicted embodiment comprises a winding key, and a timer actuation member 134, which in the depicted embodiment comprises a trigger 134. The function of these elements will be discussed in greater detail below in connection with later figures. A brewer stand 160 is positioned below central chamber 130. In some embodiments, brewer stand 160 may be a part of central chamber 130, such as positioned at a lower end of central chamber 130, for example. A brewing dripper 170 is positioned below brewer filter 150. As discussed below, brewing dripper 170 may be configured to receive a filter within a filter-receiving region 172, which, in turn, may be configured to receive a brewing material, such as coffee grounds.

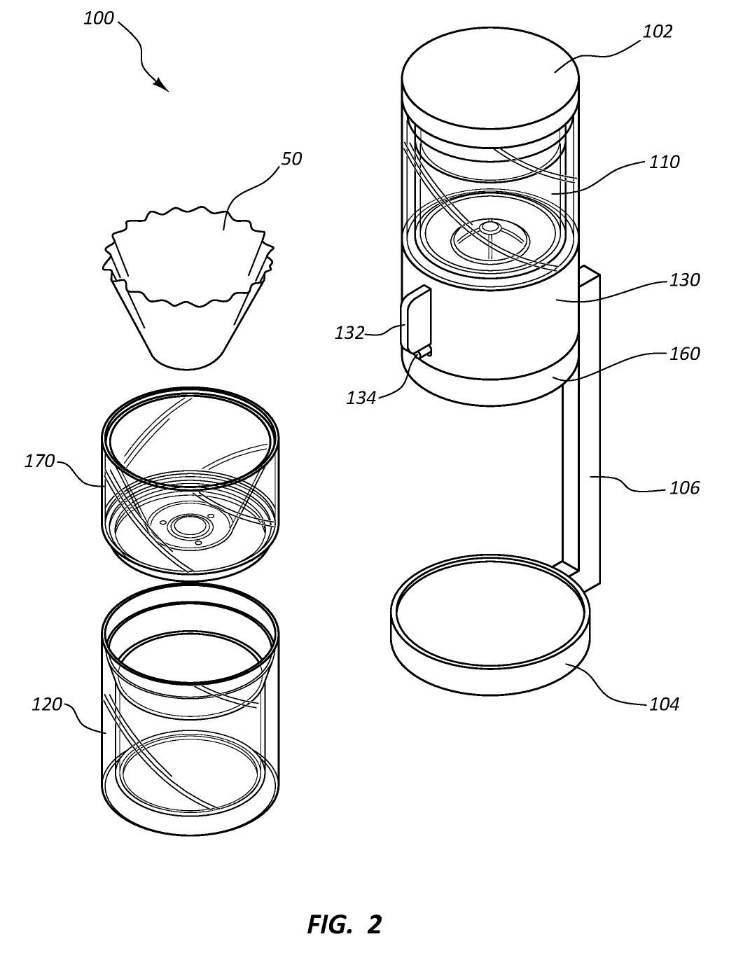

FIG. 2 is an exploded view showing each of the separable components of brewing assembly 100 removed from one another. As better seen in this figure, frame member 106 may extend from base 104 to central chamber 130 and/or brewer stand 160. However, various alternative embodiments are contemplated. For example, the various elements may be stacked on top of one another without providing frame member 106, if desired.

As also best illustrated in FIG. 2, brewing dripper 170 may be configured to be coupled with delivery chamber 120. In some embodiments, brewing dripper 170 may be configured to be at least partially received within delivery chamber 120. In this manner, a brewing sub-assembly made up of brewing dripper 170 and delivery chamber 120 may be configured to be selectively removed from brewing assembly 100.

In some embodiments, however, brewing dripper 170 may be separately removable from brewing assembly 100 relative to delivery chamber 120. In other words, delivery chamber 120 may first be removed from assembly 100 in order to allow for dispensing of a brewed beverage, and brewing dripper 170 may then be separately removed from assembly 100 in order to allow for replacement of filter 50 and/or brewing material.

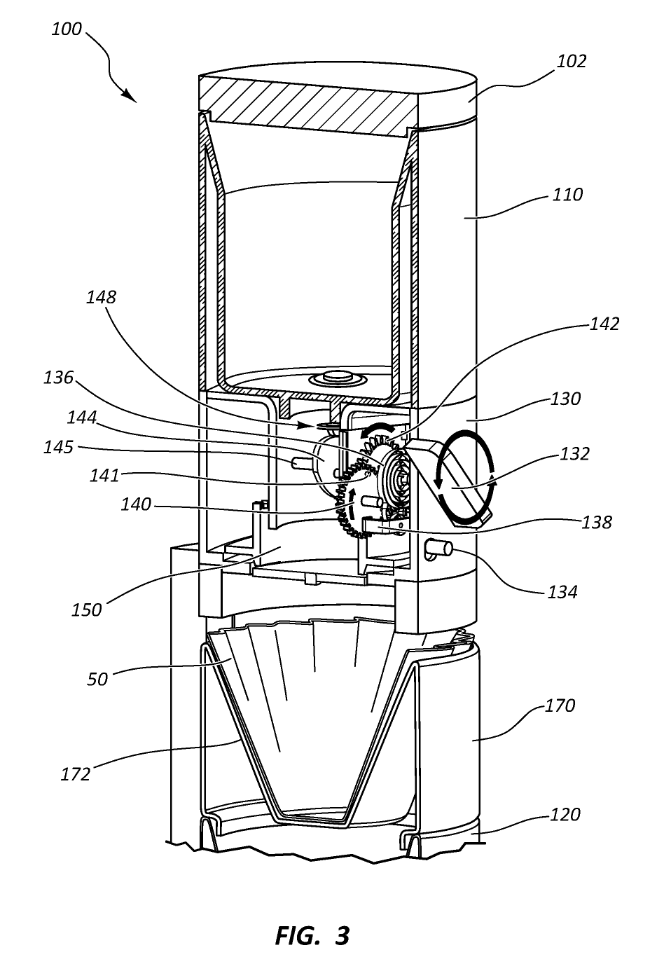

FIGS. 3-15 depict various stages of a brewing process using brewing assembly 100 according to some embodiments. As shown in FIG. 3, after inserting brewing material and, in some cases, a filter, winding key 132 may be turned, as indicated by the arrow in FIG. 3. In some embodiments, the timer-actuated valve assembly may be configured to allow for a predetermined number of turns/amount of winding to set the timer.

FIG. 3 is a cross-sectional view of brewing assembly 100 that depicts the internal components of the timer-actuated valve assembly within central chamber 130. As shown in this figure, this assembly may comprise a spring 136, such as a spiral torsion spring or another suitable spring or other biasing member, the function of which is described below. The valve assembly further comprises a trigger mechanism 138 and one or more gears, such as gears 140, and 142. Gear 140 is referred to herein as a start/stop gear and gear 142 as a dripper gear. Gear 140 comprises a peg 141, the functionality of which is described below.

Of course, any of the various springs shown in the preferred embodiment depicted in the drawings, including spring 136, may be replaced by other suitable means for rotation of cam 144 in alternative embodiments. For example, some embodiments may comprise an electric motor that may be configured to rotate cam 144. Thus, instead of winding key 132, such embodiments may, for example, be configured to allow a user to rotate cam 144 by starting such a motor or other rotation means. Similarly, various aspects/components of the brewer in such embodiments may be controlled electronically. For example, a display and/or user interface may be provided that may allow a user to control various aspects of the brewing process by, for example, controlling the rotation of shaft 145 and/or cam 144. Thus, for example, a user may be able to program the device or otherwise input instructions to control the duration and/or speed of this rotation.

In some embodiments, a user may additionally, or alternatively, be allowed to electronically control other aspects of the brewing process. For example, in some contemplated embodiments, a plurality of cam members may be provided and the brewer may be configured to allow a user to automatically exchange one cam member for another. For example, in some embodiments, a plurality of distinct cam members may be positioned on shaft 145 adjacent to one another. A motor or other actuation means may then be provided to allow shaft 145 to slide along its axis to reposition a desired cam member in alignment with dosing valve 146 and/or protrusion 148 to result in distinct liquid release and therefore brewing characteristics as desired.

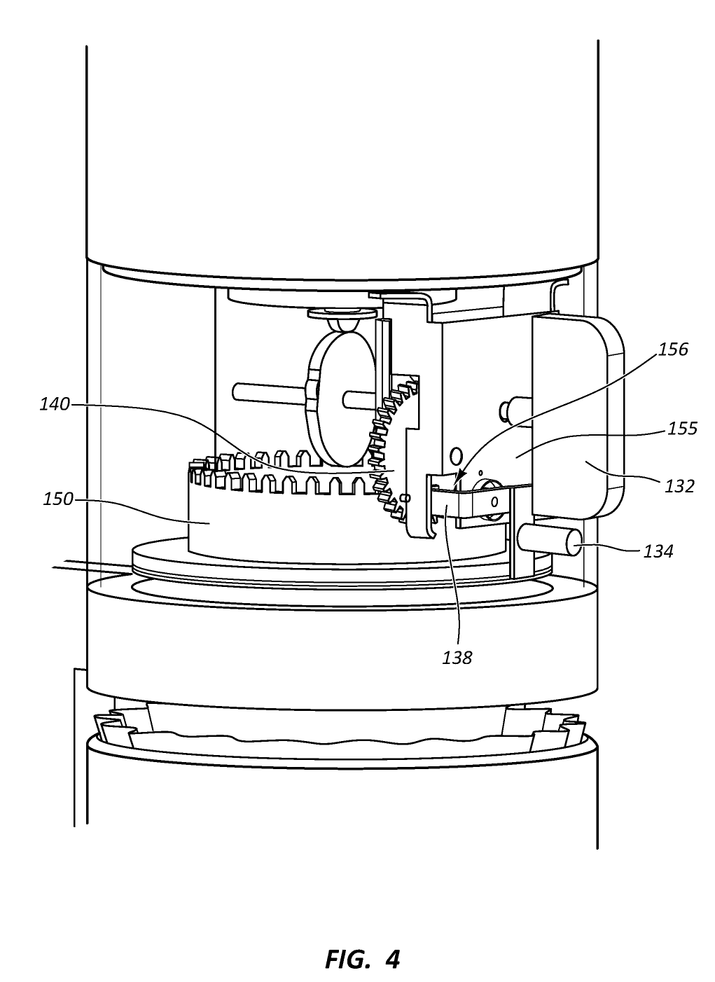

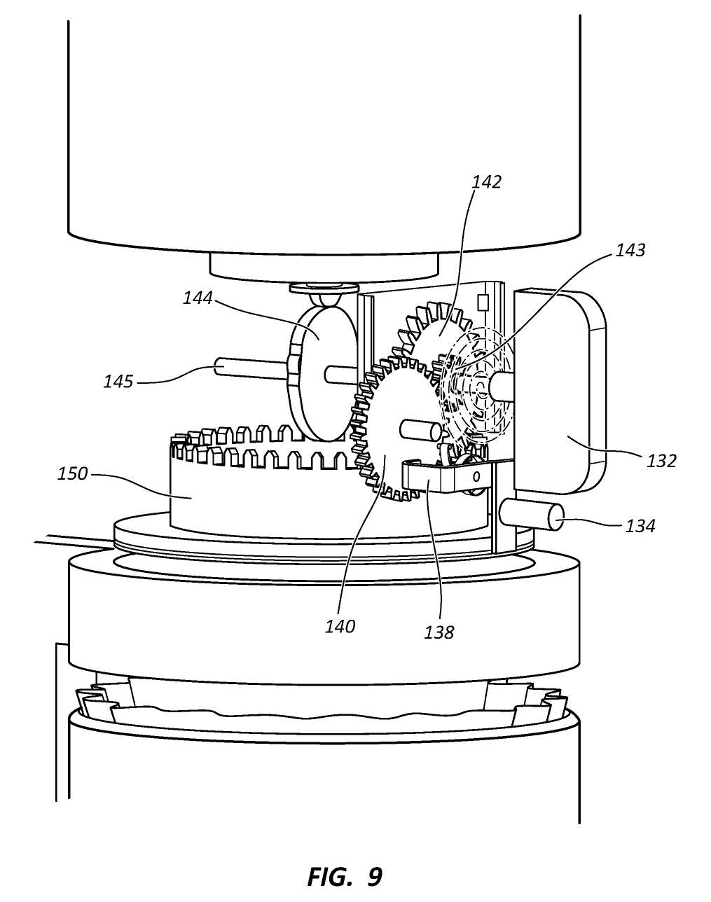

A third gear, timing gear 143, is coupled to start/stop gear 140 and shaft 145, so as to rotate cam dial 144. Timing gear 143 is not visible in FIG. 4 but can be seen in FIG. 9. The valve assembly further comprises a dosing valve 146, which may comprise or be coupled to a protrusion 148 configured to contact cam dial 144 to allow for selective opening and closing of dosing valve 146 during operation, and thereby allow for intermittent dosing of fluid, such as heated water, into coffee grounds, tea leaves and/or grounds, or another brewing material, at selected intervals. In alternative embodiments, a similar dosing valve and/or time may be used to deliver a brewed beverage out of a brewing area and/or chamber at selected intervals.

Finally, the timer-actuated valve assembly may comprise a rotating dripper 150. Rotating dripper 150 is geared and coupled with the dripper gear 142. Again, the precise functionality of these elements will be described sequentially in connection with later figures.

FIG. 4 is a close-up view again depicting the various elements of the timer-actuated valve assembly of central chamber 130. The outer walls of central chamber 130 are shown in hidden lines and, unlike FIG. 4, the full gear box frame 155 is visible. As shown in this figure, gear box frame 155 comprises a slot 156 configured to receive trigger mechanism 138, which is coupled to trigger 134.

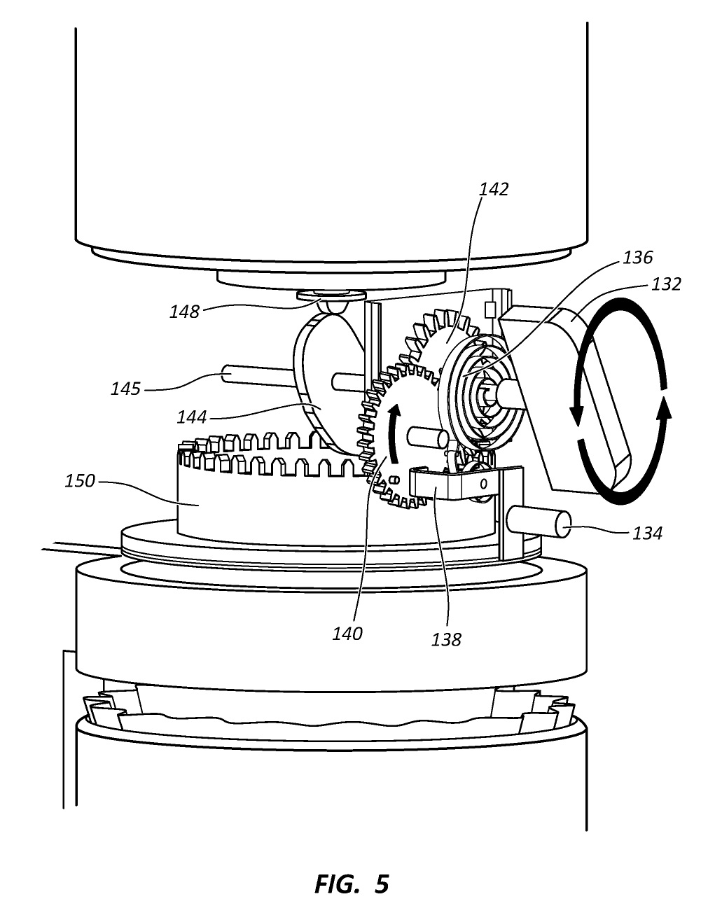

FIG. 5 is similar to FIG. 4 but with gear box frame 155 removed to allow for inspection of the components behind gear box frame 155. FIG. 5 also depicts an initial step in a preferred method for brewing a beverage according to certain implementations and will be used to begin a discussion of the various components of the timer-actuated valve assembly of brewer 100. As indicated by the arrows surrounding winding key 132, the brew process may begin with a user turning or winding key 132 in a direction opposite to a direction with which spring 136 biases winding key 132 and the shaft 145 coupled thereto (counter-clockwise in the figure). Turning key 132 in this direction causes start/stop gear 140 to turn in an opposite direction, as shown by the arrow adjacent to gear 140, due to the presence of timing gear 143 (see FIG. 9). As those of ordinary skill in the art will appreciate, timing gear 143 may comprise a gear of any desired shape so as to apply a desired ratio between the number of turns of key 132 and the number of rotations of gear 140. For example, in the depicted embodiment, the timing gear 143 is a 3:1 gear, which means three rotations of timing gear 143 are required to result in one rotation of gear 140. However, any number of alternative timing configurations are possible, depending upon the desired dosing and/or timing characteristics. In some embodiments, gears 140 and 143 may be identical and therefore the gear ratio may be 1:1.

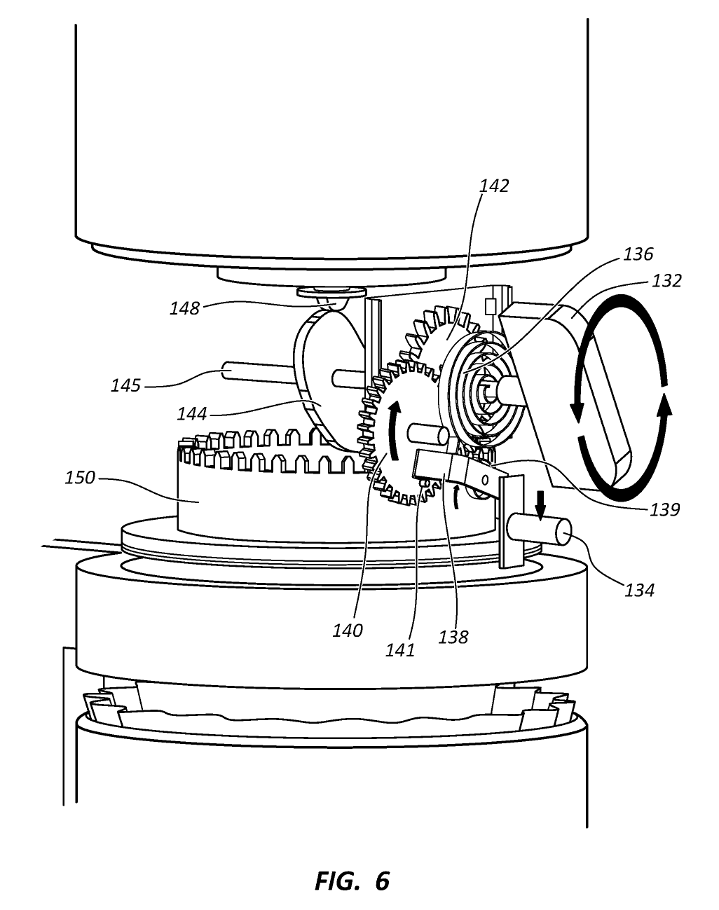

As shown in FIG. 6, once key 132 has been turned a sufficient number of times, peg 141 on gear 140 engages trigger mechanism 138, which lifts trigger mechanism 138 and causes trigger 134 to drop, as shown by the arrows in this figure. Trigger mechanism 138 may therefore be ramped on one side or otherwise configured to allow contact with peg 141 to result in lifting or other desired movement of trigger mechanism 138.

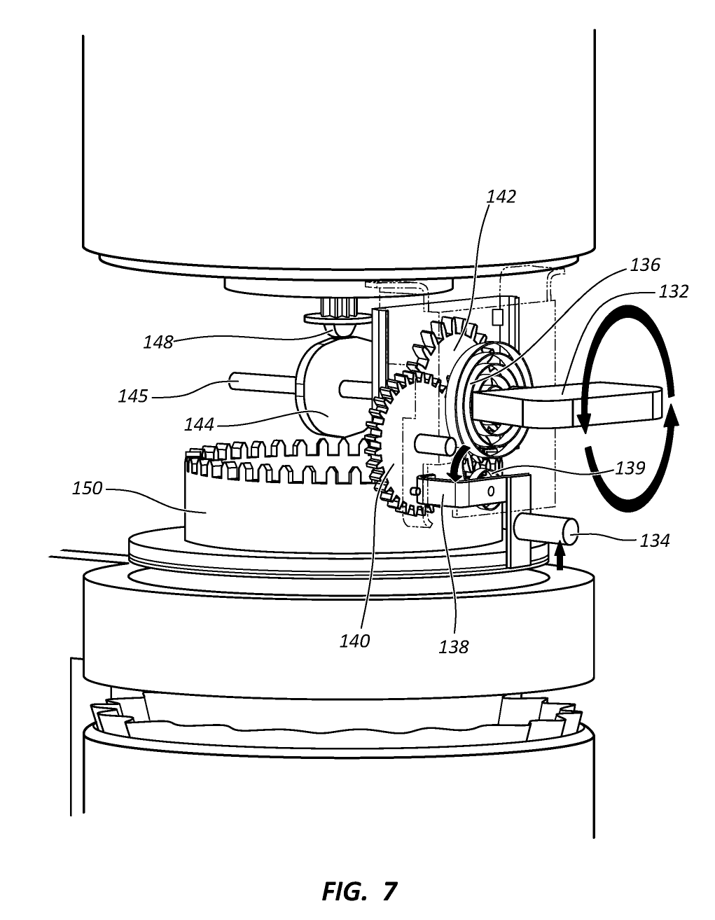

Because trigger mechanism 138 is biased towards the position shown in FIG. 5, after peg 141 has been rotated past trigger mechanism 138, trigger mechanism 138 returns to this position, as shown in FIG. 7. Another spiral torsion spring 139 or another suitable spring or other biasing member may be used to bias trigger mechanism 138, and therefore trigger 134, towards this position.

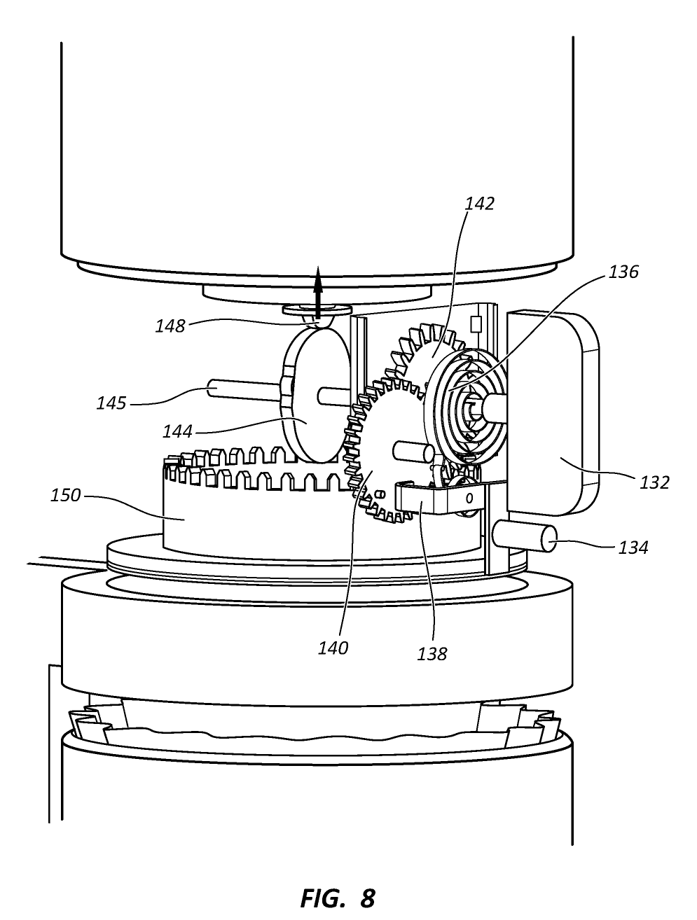

Continued rotation of key 132 results in peg 141 contacting an inner surface of gear box frame 155. In addition, although spring 136 biases gear 140 in the opposite direction, peg 141 contacts trigger mechanism 138 and prevents such movement until trigger 134 is actuated. Following such actuation, spring 136 causes gear 140 to rotate in the direction shown in FIG. 8. Turning of gear 140 results in turning of gear 142 (via timing gear 143). This, in turn, results in turning of shaft 145 and cam dial 144. Due to the elongated shape of cam dial 144, as cam dial 144 rotates, it contacts protrusion 148 of dosing valve 146 and intermittently opens and closes dosing valve 146. FIG. 7 depicts a position in which dosing valve 146 is closed, and FIG. 8 depicts a position in which dosing valve 146 is open.

In this manner, in embodiments in which the valve assembly is positioned in between the liquid chamber 110 and the brewing material, as depicted in the accompanying figures, heated water or another suitable liquid may be dosed onto the coffee grounds or other brewing material in a controlled and recurrent manner. The timing and/or other characteristics of the dosing may be altered as desired by, for example, changing the sizes/ratios of the various gears and/or by the shape of the cam dial 144.

For example, instead of having two opposing lobes on dial 144, a plurality of lobes or other protruding members may be formed about dial 144 as desired to accomplish a preferred sequence of dosing. Some such protruding members may be larger in order to allow for more fluid to be delivered through dosing valve 146 and others may be smaller in order to allow for smaller doses of fluid to be delivered therethrough. Similarly, the lateral size of such protruding members (perpendicular from the direction towards the dosing valve 146) may vary as desired in order to vary the duration of each dose.

In some embodiments, dial 144 may be removable and replaceable with other dials having other protruding members and dosing characteristics. Thus, a user may replace dial 144 in accordance with a particular brewed beverage and/or recipe/desired brewing characteristics. Also, in some embodiments, dial 144 may be used to selectively deliver a finished/brewed beverage from a brewing chamber rather than from a liquid chamber to a brewing chamber.

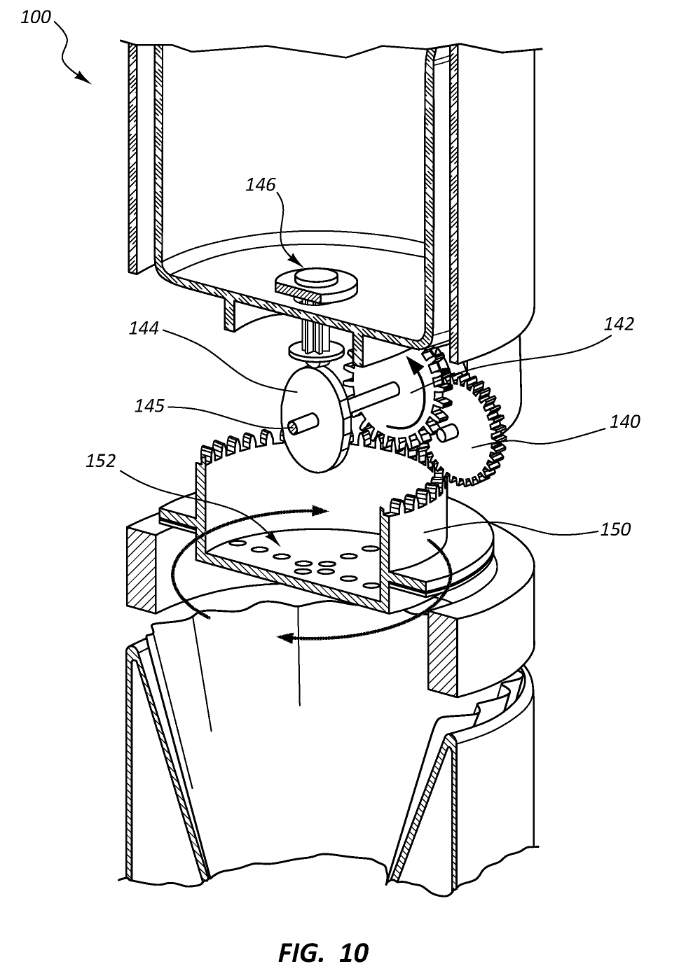

As previously mentioned, FIG. 9 depicts spring 136 in hidden lines so as to allow for viewing of timing gear 143. Again, timing gear 143 may vary to alter the ratios between the various gears as desired. FIG. 10 depicts another aspect of brewing assembly 100 in accordance with preferred embodiments. As shown in this figure, the teeth of gear 142 engage with corresponding teeth in rotating dripper 150. Thus, vertical rotation of gear 142, in addition to rotating dial 144, results in horizontal rotation of rotating dripper 150, as indicated by the arrows in FIG. 10. The base or bottom surface of rotating dripper 150 comprises a plurality of openings 152 through which heated water or another liquid from liquid chamber 110 may be delivered into the brewing material and/or filter below. By configuring the valve assembly so as to rotate dripper 150, the coffee grounds or other brewing material below may be wetted in a more even manner. In addition, the speed of rotation and the number, size, and spacing of the openings 152 may vary as desired in accordance with desired wetting characteristics.

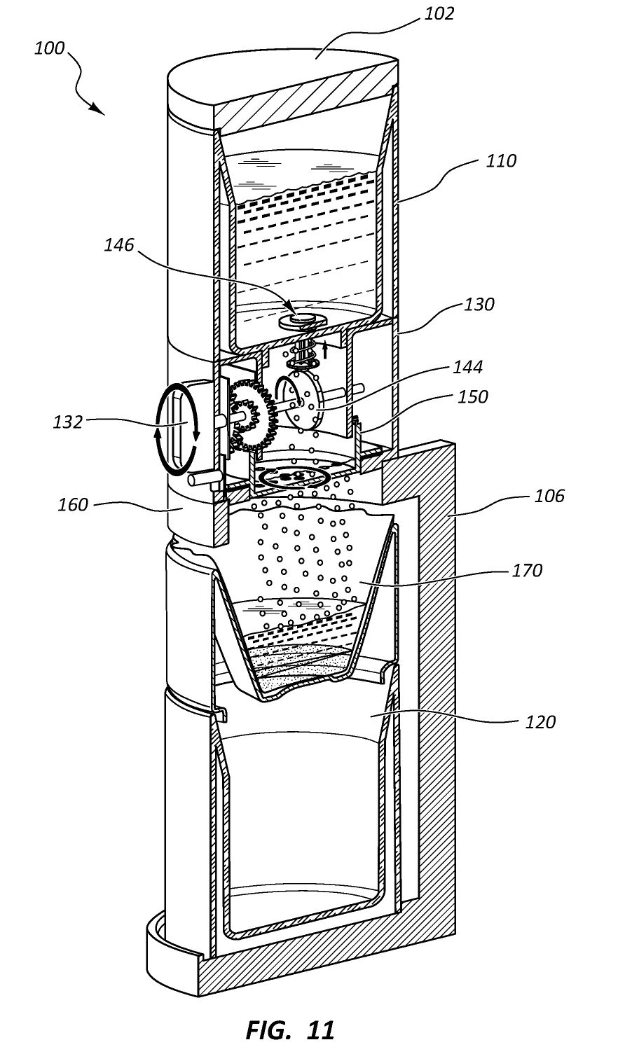

FIGS. 11-14 depict cross-sectional views of the entire brewing assembly 100 and indicate the movement of various elements in the assembly during operation. FIGS. 11-13 depict the movement of liquid from liquid chamber 110 to brewing dripper 170 and/or brewing material. As shown in these figures, as winding key 132 rotates (after being wound), water is intermittently delivered through valve 146 and is (preferably) evenly distributed using rotating dripper 150 into brewing dripper 170.

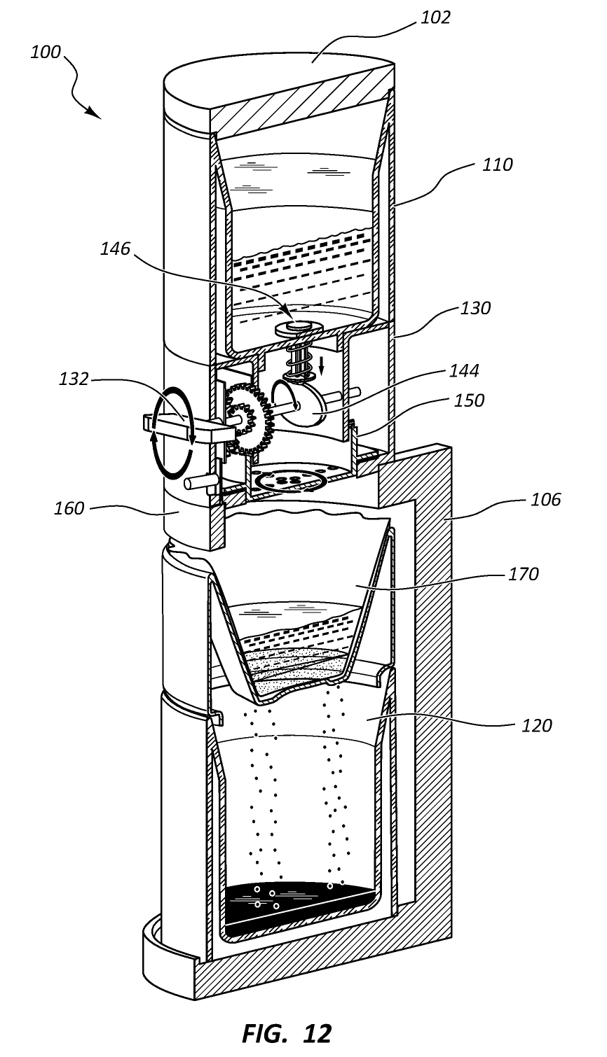

More particularly, as shown in FIG. 11, as the elongated lobes of dial 144 are aligned with dosing valve 146, water is delivered through dosing valve 146, and thereafter through the openings in dripper 150 into brewing dripper 170 and the brewing material contained therein. As shown in FIG. 12, when the elongated lobes of dial 144 are misaligned with dosing valve 146, water is prevented from flowing therethrough. However, brewed beverage may continue to be delivered from the brewing material in dripper 170 into delivery chamber 120. In some embodiments, a second valve assembly may be positioned to selectively deliver brewed beverage from a container containing the brewing material. Alternatively, the valve assembly discussed above may instead be positioned in between the brewing material and the finished beverage container. This may allow for selectively controlling the time within which the water/liquid is in contact with the brewing material.

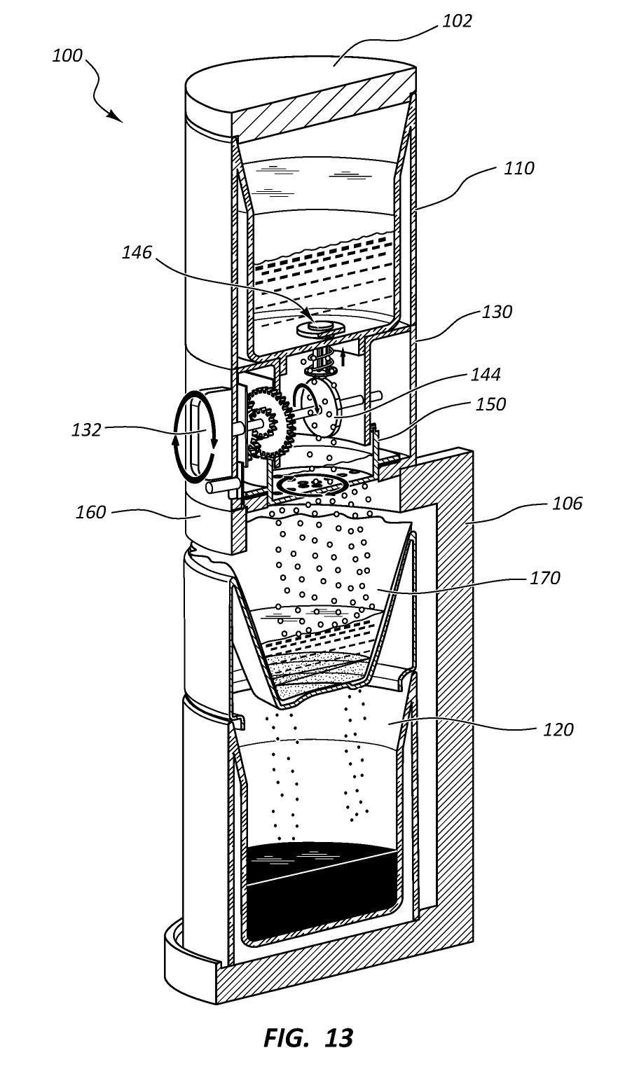

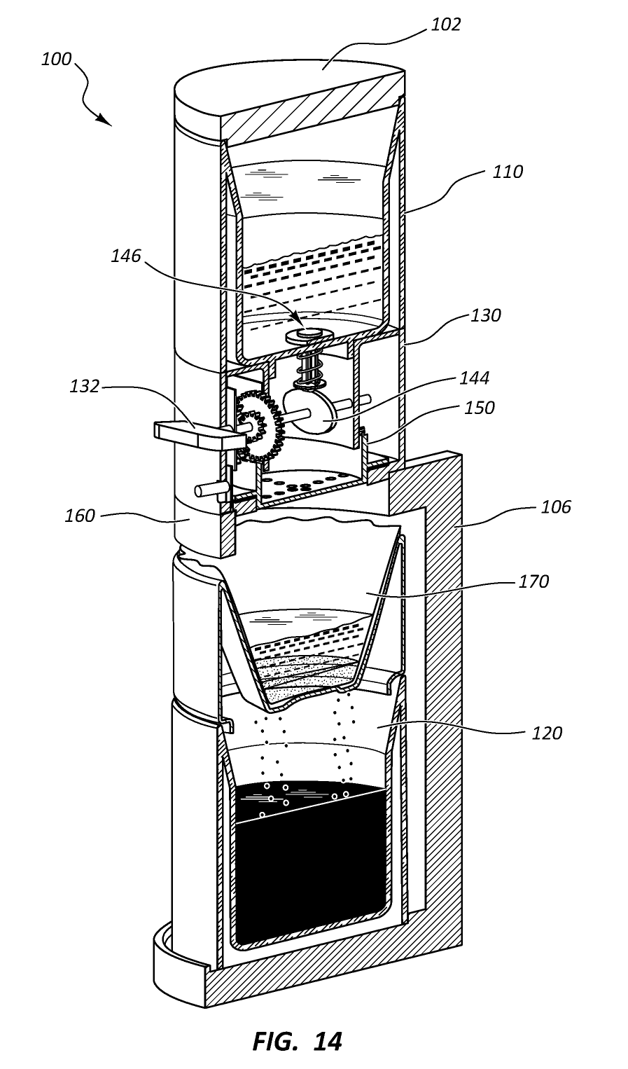

FIG. 13 indicates that the delivery of water from liquid chamber 110 may continue in an intermittent fashion as dial 144 continues to rotate through the brewing cycle. As shown in FIG. 14, once the dosing cycle has completed, brewing may continue and the brewed beverage may continue to drip/be delivered into the delivery chamber 120.

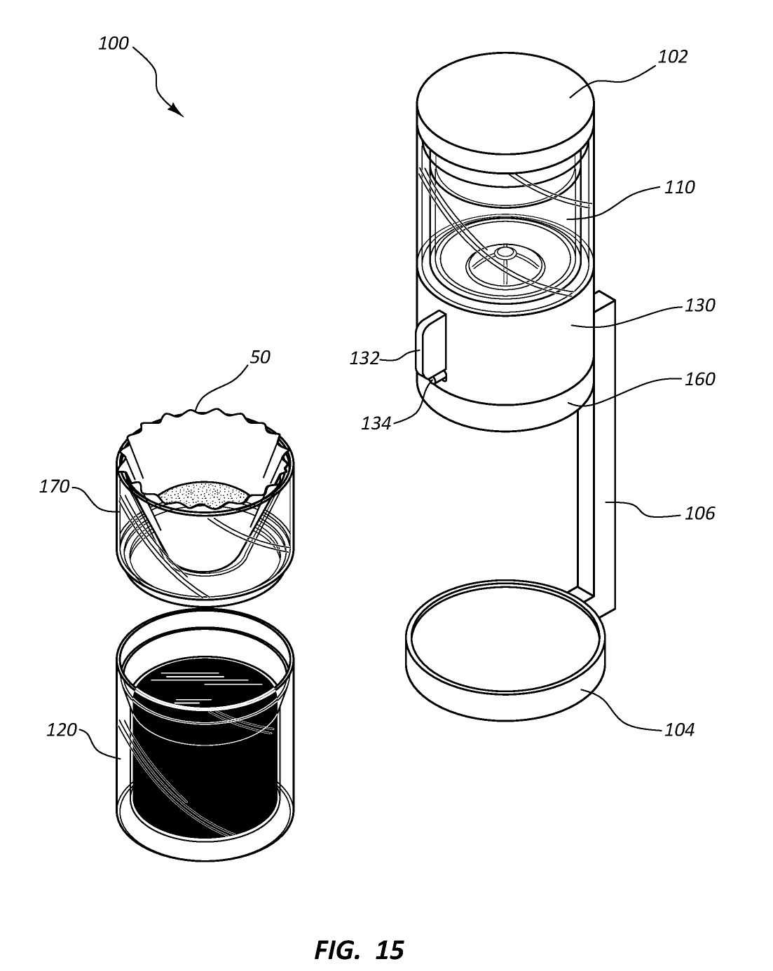

Finally, as shown in FIG. 15, once the entire brewing process has been completed, delivery chamber 120 may be removed from the assembly and either used to consume or pour the brewed beverage into another container. Similarly, the filter 50 and/or brewing material in dripper 170 may be replaced for a subsequent brew.

It will be understood by those having skill in the art that changes may be made to the details of the above-described embodiments without departing from the underlying principles presented herein. Any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

1. brewing assembly for brewing a beverage, comprising:
a liquid chamber configured to receive a liquid for use in brewing a beverage; and
a valve assembly operably coupled with the liquid chamber, wherein the valve assembly comprises:
a valve configured to be repositioned between an open configuration in which a liquid may be delivered through the valve and a closed configuration in which a liquid is prevented from passing through the valve; and
a timer configured to intermittently actuate the valve between its open and closed configurations.

2. The brewing assembly of claim 1, wherein the valve assembly is directly coupled with the liquid chamber such that the liquid chamber is configured to deliver a liquid to the valve of the valve assembly.

3. The brewing assembly of claim 1, further comprising a delivery chamber configured to receive a brewed beverage following brewing.

4. The brewing assembly of claim 3, wherein the valve assembly is positioned and configured to deliver the brewed beverage into the delivery chamber.

5. The brewing assembly of claim 1, wherein the valve assembly further comprises a rotating dial configured to intermittently actuate the valve between its open and closed configurations as the rotating dial rotates.

6. The brewing assembly of claim 5, wherein the rotating dial comprises a lobe, and wherein the lobe is configured to open the valve when aligned with the valve.

7. The brewing assembly of claim 5, wherein the rotating dial is removable, wherein the brewing assembly comprises a second rotating dial that differs from the rotating dial, and wherein the brewing assembly is configured to allow the second rotating dial to be installed in place of the rotating dial to alter the brewing characteristics of the brewing assembly.

8. The brewing assembly of claim 1, further comprising a rotating dripper configured to deliver a liquid onto a brewing material.

9. The brewing assembly of claim 8, wherein the rotating dripper is operably coupled with the valve assembly such that the brewing assembly is configured to rotate the rotating dripper as the valve is intermittently actuated between its open and closed configurations.

10. The brewing assembly of claim 1, wherein the timer comprises:
a winding key; and
a trigger configured to actuate the timer.

11. A brewing assembly for brewing a beverage, comprising:
a liquid chamber configured to receive a liquid for use in brewing a beverage;
a brewing chamber configured to receive brewing material for brewing a beverage;
a delivery chamber configured to receive a brewed beverage from the brewing chamber; and
a valve assembly positioned in between the liquid chamber and the delivery chamber, wherein the valve assembly comprises:
a shaft;
a non-circular rotating dial coupled with the shaft; and
a valve configured to be repositioned between an open configuration in which the liquid from the liquid chamber may be delivered through the valve into the brewing chamber and a closed configuration in which a liquid is prevented from passing through the valve, wherein the shaft is configured to rotate to intermittently actuate the valve between its open and closed configurations by rotating the non-circular rotating dial.

12. The brewing assembly of claim 11, further comprising a winding key coupled with the shaft.

13. The brewing assembly of claim 11, further comprising a trigger configured to, upon actuation, rotate the shaft.

14. A method for brewing a beverage, the method comprising the steps of:
loading a brewing material into a brewing chamber of a beverage brewer;
actuating a timer of the beverage brewer;
delivering a liquid in an intermittent manner through a valve of the beverage brewer; and
brewing a beverage using the beverage brewer.

15. The method of claim 14, wherein the step of actuating the timer of the beverage brewer results in automatically delivering the liquid through the valve in an intermittent manner.

16. The method of claim 15, wherein the step of actuating the timer of the beverage brewer results in a shaft rotating, wherein the shaft comprises a cam member, and wherein the rotation of the cam member causes the valve to intermittently open and close.

17. The method of claim 14, further comprising, following the step of brewing the beverage, resetting the timer.

18. The method of claim 17, wherein the step of resetting the timer comprises turning a winding key.

19. The method of claim 14, wherein the step of actuating the timer of the beverage brewer comprises electronically actuating the timer.

20. The method of claim 14, wherein the step of delivering a liquid in an intermittent manner through a valve of the beverage brewer comprises delivering a liquid from a liquid chamber of the beverage brewer into the brewing material in the brewing chamber.
